(19) United States
(12) Patent Application Publication
(10) Pub. No.: US 2010/0232506 A1
(43) Pub. Date: Sep. 16, 2010

(54) METHOD FOR HANDLING LOCAL BRIGHTNESS VARIATIONS IN VIDEO

(76) Inventors: Peng Yin, West Windsor, NJ (US); Jill MacDonald Boyce, Manalapan, NJ (US); Alexandros Tourapis, Burbank, CA (US)

Correspondence Address: Robert D. Shedd, Patent Operations;THOMSON Licensing LLC, P.O. Box 5312, Princeton, NJ, 08543-5312, US

(21) Appl. No.: 12/223,890

(22) PCT Filed: Feb. 17, 2006
(86) PCT No.: PCT/US06/05904

§ 371 Date: Aug. 12, 2008

(51) Int. Cl. H04N 7/32

(52) U.S. Cl. 375/240.16; 375/240.12; 375/E07.123

(57) ABSTRACT

There is provided a compression method for handling local brightness variation in video. The compression method estimates the weights from previously encoded and reconstructed neighboring pixels of the current block in the source picture and their corresponding motion predicted (or collocated) pixels in the reference pictures. Since the information is available in both the encoder and decoder for deriving these weights, no additional bits are required to be transmitted.

### BACKGROUND OF THE INVENTION

1. Field of the Invention

The present invention relates to video coding. More particularly, it relates to a method for handling local brightness variation in video using localized weighted prediction (LWP).

2. Description of the Prior Art

Video compression codecs gain much of their compression efficiency by forming a reference picture prediction of a picture to be encoded, and only encoding the difference between the current picture and the prediction using motion compensation (i.e., interframe prediction). The more closely correlated the prediction is to the current picture, the fewer the bits that are needed to compress that picture.

In earlier video codecs, the reference picture is formed using a previously decoded picture. Unfortunately, when serious temporal brightness variation is involved, e.g. due to illumination changes, fade-in/out effects, camera flashes etc, conventional motion compensation can fail.

The JVT/H.264/MPEG4 AVC video compression standard is the first international standard that includes a weighted prediction (WP) tool. This WP tool works well for global brightness variation, but due to the limitation of the number of different weighting parameters that can be used, little gain can be achieved in the presence of significant local brightness variation.

The weighted prediction (WP) tool in H.264 has been used to improve coding efficiency over prior video compression standards. WP estimates the brightness variation by a multiplicative weighting factor a and an additive weighting offset b as in exemplary equation (1):

I(x,y,t)=a·I(x+mvx, y+mvy,t−1)+b (1)

where I(x, y, t) is the brightness intensity of pixel (x, y) at time t, a and b are constant values in the measurement region, and (mvx,mvy) is the motion vector.

Weighted prediction is supported in the Main and Extended profiles of the H.264 standard. Use of weighted prediction is indicated in the picture parameter sets for P and SP slices using the weighted_pred_flag field, and for the B slices using the weighted_bipred_idc field. There are two WP modes, explicit mode which is supported in P, SP and B slices, and implicit mode, which is supported in B slices only.

In WP, the weighting factor used is based on the reference picture index (or indices in the case of bi-prediction) for the current macroblock or macroblock partition. The reference picture indices are either coded in the bitstream or may be derived (e.g., for skipped or direct mode macroblocks). A single weighting factor and a single offset are associated with each reference picture index for all slices of the current picture. For the explicit mode, these parameters are coded in the slice header. For the implicit mode, these parameters are derived. The weighting factors and offset parameter values are also constrained to allow 16 bit arithmetic operations in the inter predication process.

FIG. 1 shows examples of some macroblock partitions and sub-macroblock partitions in the H.264 standard. H.264 uses tree-structure hierarchical macroblock partitions, where 16×16 pixel macroblock may be further broken into macroblock partitions of sizes 16×8, 8×16, or 8×8. An 8×8 macroblock partition can be further divided into sub-macroblock partitions of sizes 8×4, 4×8, and 4×4. For each macroblock partition, a reference picture index, prediction type, and motion vector may be independently selected and coded. For each sub-macroblock partition, a motion vector may be independently coded, but the reference picture index and prediction type of the sub-macroblock is used for all of the sub-macroblock partitions.

The explicit mode is indicated by weighted_pred_flag equal to 1 in P or SP slices, or by weighted_pred_idc equal to 1 in B slices. As we have mentioned previously, in this mode, the WP parameters are coded in the slice header. A multiplicative weighting factor and an additive offset for each color component may be coded for each of the allowable reference pictures in a list 0 is indicated by num_ref_idx_10_active_minus1, while for list 1 (for B slices) this is indicated by num_ref_idx_11_active_minus1. All slices in the same picture must use the same WP parameters, but they are retransmitted in each slice for error resiliency.

For global brightness variation that is uniformly applied across an entire picture, a single weighting factor and offset are sufficient to efficiently code all macroblocks in a picture that are predicted from the same reference picture.

However, for brightness variation that is non-uniformly applied, e.g. for lighting changes or camera flashes, more than one reference picture index can be associated with a particular reference picture store by using reference picture reordering. This allows different macroblocks in the same picture to use different weighting factors even when predicted from the same reference picture store. Nevertheless, the number of reference pictures that can be used in H.264 is restricted by the current level and profile, or is constrained by the complexity of motion estimation. This can considerably limit the efficiency of WP during local brightness variations.

Thus, it becomes apparent that there is a need for a compression method that handles local brightness variations without the aforementioned drawbacks associated with the WP tool in H.264.

### SUMMARY OF THE INVENTION

It is therefore an aspect of the present principles to provide a coding method overcomes the shortfalls of the prior art and which can handle local brightness variation more efficiently.

It is another aspect of the present principles to provide a localized weighting prediction that is implemented into the H.264 standard.

According to one embodiment of the present principles, the method for handling local brightness variations in video includes generating and using a block wise additive weighting offset to inter-code the video having local brightness variation, and coding the block wise additive weighting offset. The generating can include using a down-sampled differential image between a current picture and a reference picture, and the coding can be performed explicitly. The coding could also be performed using available intra-coding methods.

In another embodiment, the method further includes constructing the differential image in an encoder, and considering motion estimation and motion compensation during said constructing in the encoder. The differential image cane be a DC different image, the transmitting is performed only on the used portions of the differential image. Unused portion for the differential image can be coded using easily coded values.

In a further embodiment of the present principles, a new reference picture is generated by adding an up-sampled DC differential image to a decoded reference picture, and filtering the new reference picture. The filter removes blockiness from the new reference picture and can be, for example, a deblocking filter in H.264. The generation of the new reference picture can coding can be integrated into video codec, while an additional bit in the signal header is used during the coding.

In accordance with the one embodiment of the present principles, the generating and coding is applied to a Y (or luma) component in the video. In another embodiment, the generating and coding is applied to all color components (e.g., U and V (chroma) components). The applying in this step can be implicitly defined/signaled.

According to yet a further embodiment of the present principles, the method for coding video to handle local brightness variation includes: generating a DC differential image by subtracting a current picture from a reference picture; reconstructing the reference picture by adding the generated DC differential image; motion compensating the reconstructed reference picture with respect to the video; and encoding residue from the motion compensating.

The method for handling local brightness variation in an H.264 encoder can include: determining whether H.264 inter-coding is present on the video, and when H.264 coding is not present; computing a differential image for a current picture in the video; encoding the differential image; decoding and upsampling the differential image; forming a new reference picture; motion compensating the new reference picture; calculating a DC coefficient of motion compensated residual image information; and encoding the DC coefficient of the motion compensated residual image information. The decoded and up-sampled differential image can then be filtered to remove blockiness.

In accordance with further embodiments, the method for handling local brightness variation includes decoding received video that is not H.264 inter-coded in an H.264 decoder. The decoding further includes decoding the encoded differential image, upsampling the decoded differential image, forming a new reference picture from the up-sampled image and a reference picture store; decoding the residual image information, and motion compensating the new reference picture with the decoded residual image information to produce the current picture.

Other aspects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is block diagram showing macroblock partitioning according the H.264 standard;

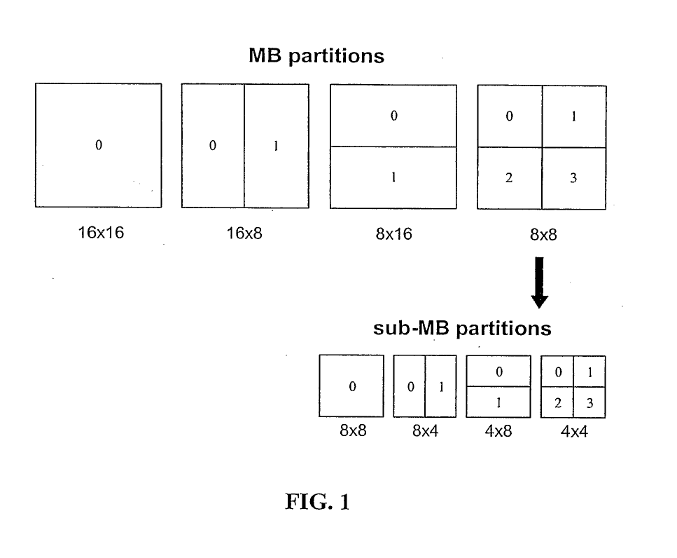

FIG. 2 is a diagrammatic representation of motion compensation in the localized weighted prediction method according to an embodiment of the present principles;

FIG. 3a is a flow diagram of the coding method to handle local brightness implemented in an encoder according to an embodiment of the present principles;

FIG. 3b is a flow diagram of the combination of the coding method of the present principles with the H.264 standard in an encoder;

FIG. 4a is a flow diagram of the coding method to handle local brightness implemented in an decoder according to an embodiment of the present principles; and

FIG. 4b is a flow diagram of the combination of the coding method of the present principles with the H.264 standard in a decoder.

### DETAILED DESCRIPTION OF PREFERRED EMBODIMENTS

According to one embodiment of the present principles, a new compression method to handle local brightness variations is provided. In this embodiment, a DC differential image is generated by subtracting the current picture and the reference picture, and the reference picture is reconstructed by adding the generated DC image.

From Equation 1 above, it is also noted that in order to be able to efficiently handle local brightness variations, it may be necessary to code a large set of weighting Parameters a and b. Unfortunately, this can create two problems: 1) many bits are needed to code these parameters; and 2) the computational complexity mainly in the encoder could be rather high, considering that it would be necessary to generate the required references and perform motion estimation/compensation (ME) using all possible sets of a and b.

According to one embodiment of the present principles, if we assume that the spatial variance of the intensity in a region is small, we can approximately represent the brightness variation inside a small region by only using a weighting offset term b, i.e., setting a=1. According to one known method, this offset is absorbed in the DC coefficient of the motion compensated residue, since it is assumed to be spatially uncorrelated. In this case though this claim is not always true thus limiting coding efficiency. In order to handle the offset in motion estimation/compensation, the mrSAD metric is used rather than the normal SAD metric. The Sum of Absolute Differences (SAD) is defined as:

$$S A D = {\sum }_{[ x , y ] ∈ {B}_{k}} \vert c [ x , y ] - r [ x , y ] \vert \qquad ( 3 )$$

where mrSAD is:

$$mrSAD = {\sum }_{[ x , y ] ∈ {B}_{k}} \vert c [ x , y ] - mean ( c ( {B}_{k} ) ) - ( r [ x , y ] - mean ( r ( {b}_{k} ) ) ) \vert \qquad ( 4 )$$

where c indicates current picture, r is for reference picture and Bₖ is for block k.

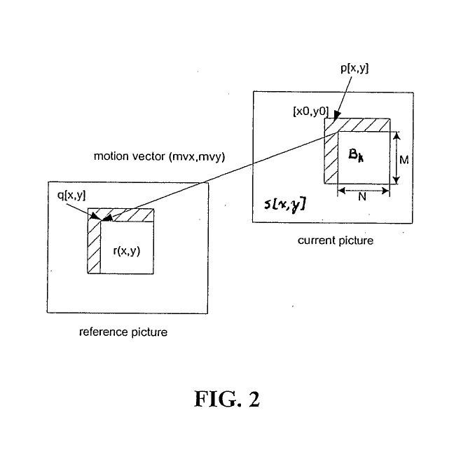

According to an embodiment of the present principles (and as shown in the exemplary diagram of FIG. 2), a method is provided for coding the weighting offset term. If it is assumed that the motion is small between the current picture c and reference picture r, we can define b(x,y)=c(x,y)−r(x,y). If the brightness variation is also assumed to be small within a small block, we arrive at b(Bₖ)=D(c(Bₖ)−r(Bₖ)), where D indicates an operator to extract the offset of the particular block Bₖ from the current and reference pictures. D can be any known sub-sampling method, such as, for example, the full or decimated block's mean. Using this method, a new sub sampled picture sD (if mean is used for D, sD is equivalent to a DC differential image between c and r). In general, the sD image can be generated as sD=G(c-H(r)) where H( ) can, for example, be a motion compensated process, while G ( ) can be another operator (e.g., N×M mean) which can provide a better representation for sD (i.e., in terms of coding efficiency).

A new reference picture r′ is formed by r′=F(r+U(sD)), where U indicates an operator to upsample the sD image to the full size, F is a filter to remove the blocky artifact caused by sD, which could, for example, be similar to the deblocking filter used in H.264, or any other appropriate deblocking filter. Motion compensation is then performed on r′. It is noted that it may not be necessary to have all pixels in sD since such may not be used. For example, for intra-coded blocks, the non referenced pixels can either be forced to zero or to any easily compressed value, such as the value of a neighboring pixel, regardless of their actual value. Alternatively, a map may be submitted which indicates the used region of sD. In any event, such process can only be made after the motion estimation/decision, and sD would require re-encoding in such a manner that does not change the values of the reference regions.

It is also possible, although considerably more complex, to generate the sD image after considering some motion information between the current image and its reference. This could allow for better estimation of the necessary offset for each position, and improve coding efficiency of the sD image, but also of the final reconstructed image.

Those of skill in the art will recognize that the method of the present principles can be combined with any block-based motion compensated codecs. By way of example, H.264 is used in the present disclosure.

In implementing the method of the present principles, there are some considerations that must be made:

1) Block size—If the block size Bₖ is too small, more bits are necessary for coding sD.

If the size is too large, it may not be possible to accurately catch the local brightness variation. It is proposed to use a block size of 8×8, as testing has shown this provides a good trade off;

2) Selection of operators—For simplicity, the present disclosure uses mean for D (so sD is essentially a DC differential image) and first order upsampling (simple repeating) for U. An alternative method would be to upsample I while taking special consideration of block boundaries where we instead use the average value from the adjacent blocks. Finally for F, the deblocking filter used in H.264 for deblocking macroblocks can be used;

3) Coding method for sD—Since H.264 is very efficient in coding intra picture, the sD image can be coded as an H.264 intra picture;

4) Syntax changes—The method of the present principles can be combined with the current H.264 codec and syntax. For example, we can have one parameter (i.e., within the picture parameter sets) which will signal whether this method is to be used of the current picture/slice. Furthermore, for each reference a separate parameter is transmitted (i.e., within the slice parameter sets) that indicates if a differential DC image would be used Or not to form a new reference picture. Finally, during encoding, all possible variations could be tested and using the existing exhaustive Langragian Rate Distortion Optimization (RDO) method, select the most appropriate method for each reference picture, compared to also the original (non differential DC) method; and

5) Color Component Generalization—The same method can be use only for the Y (or luma) component, or selectively for all components (e.g., U and V(chroma) components). Selection could be done either implicitly or explicitly through the use of picture or slice parameters.

Those of skill in the art will recognize that different variable designations and block sizes can be used without departing from the spirit of the present principles.

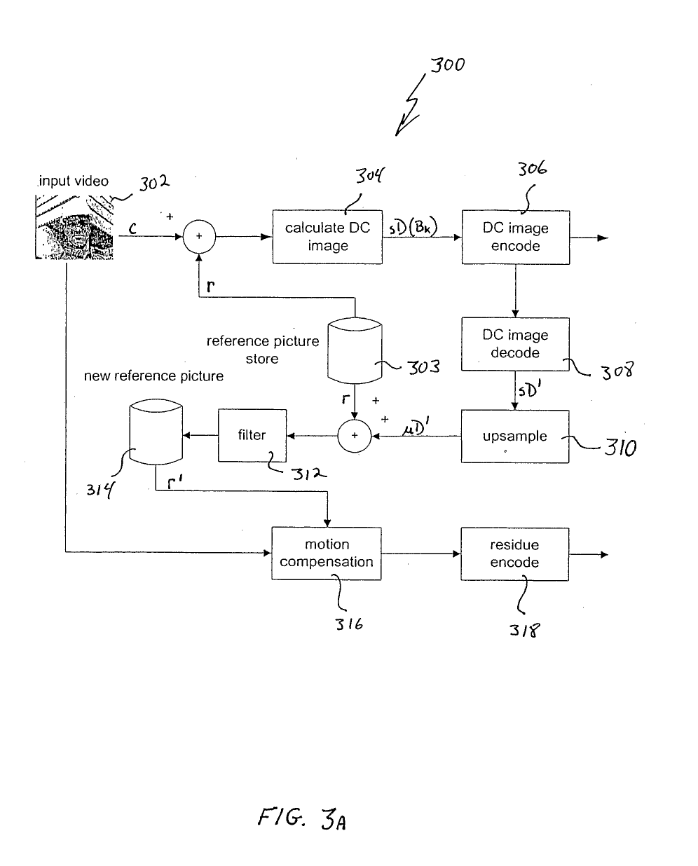

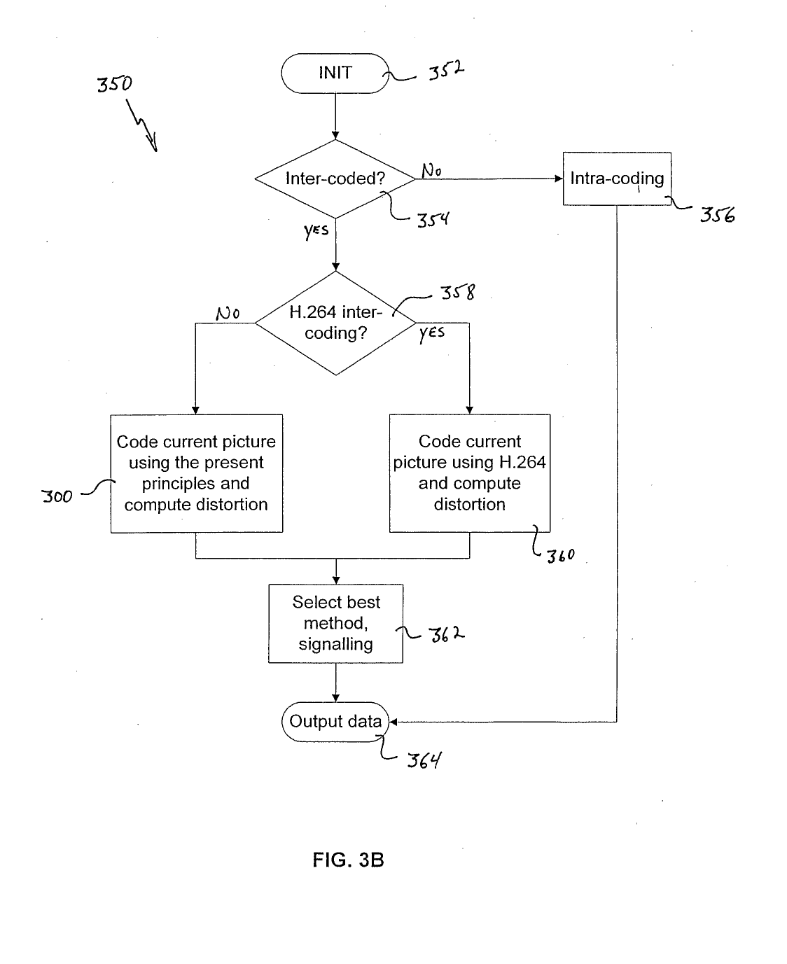

FIG. 3a shows a block diagram of an embodiment of the method of the present principles at the encoder end. An input image or current picture c is input and the differential DC image sD(Bₖ)=mean(c(Bₖ)−r(Bₖ)) is computed 304 for all blocks (Bₖ). The differential DC image sD(Bk) is encoded 306 using the intra slice method, as in H.264. The DC image sD(Bₖ) is then decoded 308 as (sD′) and then up-sampled 310 to uD′. The new reference picture r′ is formed 314 by adding the up-sampled image uD′ to the reference picture r from reference picture store 303 and filtering 312 the same to remove block artifacts (i.e., r′=uD′+r). Motion compensation 316 is performed on the new reference picture r′ and the DC coefficient of the motion compensated residue is encoded 318.

If further compression of sD is desired based on the results of the motion estimation/compensation, at this step sD would need to be recompressed to a picture sD″ while both: 1) considering the results of this motion estimation/compensation; and 2) ensuring that the motion compensation gives identical results (e.g., if for example for a particular reference we do not refer to any pixels at the lower or right regions, the values of those regions can be set to zero without affecting the decoding process).

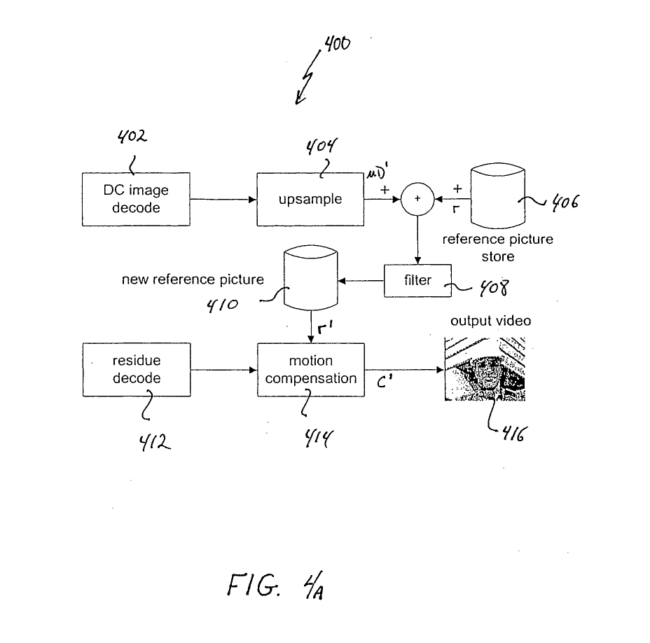

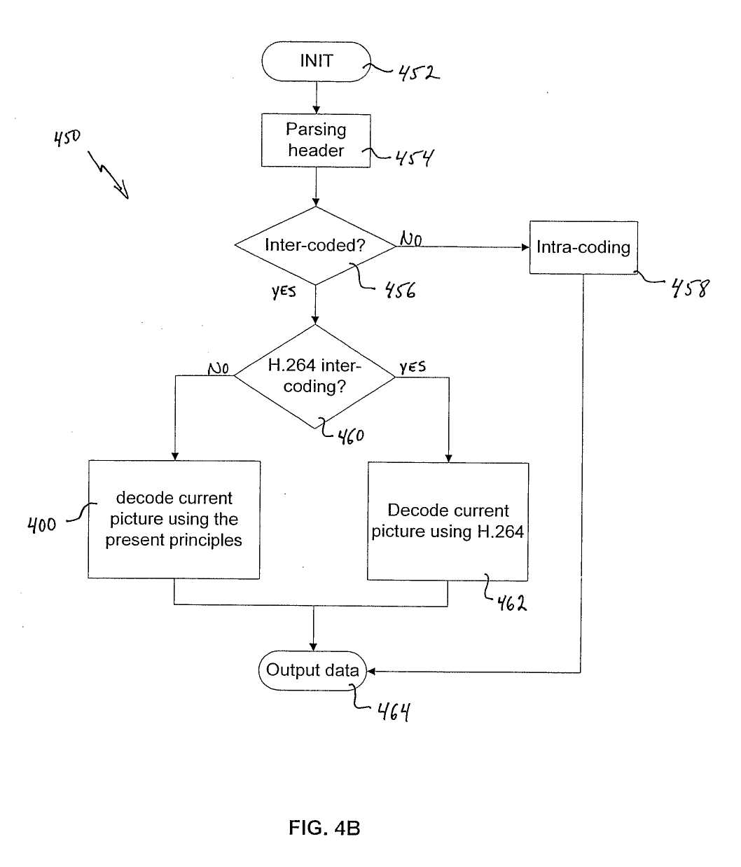

As will be explained later with reference to FIGS. 3b and 4b, the Localized Weighting Prediction (LWP) method of the present principles can be implemented into the H.264 standard.

Referring to FIG. 4a, at the decoder if a differential DC image is received for a previously decoded reference r, the DC image sD′ is decoded 402 and up-sampled 404 to uD′. The new reference picture 410 is formed by adding the up-sampled image uD′ to the reference r, filtering 408 to remove blocky artifacts (i.e., r′=uD′+r). The residue is decoded 412, and motion compensation 414 is performed in r′ in order to produce the current picture c′ (416).

FIGS. 3b and 4b show the implementation of the LWP method of the present principles combined with the H.264 standard in an encoder and decoder, respectively. In accordance with one embodiment, the present method requires a simple syntax modification in order to be combined with H.264. More specifically, a single bit is added within the picture parameter sets of H.264 to indicate whether this method is to be used for the current picture/slice. An alternative way is to add an additional signal in the slice header which could allow further flexibility (i.e., by enabling or disabling the use of LWP for different regions).

As shown in FIG. 3b, the process 350 includes an initialization 352, and a first determination as to whether the picture is inter-coded (354). If not inter-coded, intra-coding is performed (356) and the data is output (364). If inter-coded, the next determination is whether H.264 inter-coding should be used (358). We first code the current picture using H.264 inter-coding method and compute distortion. We then code the current picture using the LWP method (360) of the present principles (300) and compute the distortion. The best method is selected using the method with less distortion and is signaled (362). The data is output (364).

FIG. 4b shows the decoder process 450 of the combined LWP and H.264 according to an embodiment of the present principles. After initialization (452), the parsing header 454 is read, and a determination as to whether the current picture is inter-coded (456) is performed. If no, as with the encoder, the intra-coding is performed (458) and the data is output (464). If the current picture is inter-coded, it is next determined whether it is H.264 inter-coding (460). If yes, the current picture is decoded using H.264 (462) and output (464). If no H.264 inter-coding, the current picture is decoded using the LWP method 400 of the present principles.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

1. A method for coding video to account for local brightness variations comprising the steps of:
generating block-wise additive weighting offsets to inter-code the video having local brightness variation; and
coding the block wise additive weighting offsets.

2. The method according to claim 1, wherein said generating step further comprises the step of generating such offsets using a down-sampled differential image between a current picture and a reference picture.

3. The method according to claim 1, wherein said coding is performed explicitly.

4. The method according to claim 2, wherein said differential image comprises a DC differential image.

5. The method according to claim 2, further comprising:
constructing the differential image in an encoder; and
considering motion estimation and motion compensation during said constructing in the encoder.

6. The method according to claim 2, further comprising transmitting only used portions of the differential image.

7. The method according to claim 2, further comprising coding unused portions of the differential image using easily coded values.

8. The method according to claim 1, further comprising:
generating a new reference picture by adding an up-sampled DC differential image to a decoded reference picture; and
filtering the new reference picture.

9. The method according to claim 8, wherein said filtering comprises a deblocking filter in H.264.

10. The method according to claim 8, wherein said filtering comprises removing blockiness from the new reference picture.

11. The method according to claim 1, further comprising:
integrating said generating and coding into a video codec; and
using an additional bit in a signal header during said coding.

12. The method according to claim 1, further comprising applying said generating and coding to a Y component in the video.

13. The method according to claim 1, further comprising applying said generating and coding to all color components in the video.

14. The method according to claim 13, wherein said applying is implicitly defined.

15. The method according to claim 1, wherein said coding further comprises explicitly coding the block wise additive weighting offset using intra-coding methods.

16. A method for coding video to account for local brightness variation, the method comprising the steps of:
generating a DC differential image by subtracting a current picture from a reference picture;
reconstructing the reference picture by adding the generated DC differential image;
motion compensating the reconstructed reference picture with respect to the video; and
encoding residue from the motion compensating.

17. A method for accounting for local brightness variation in an H.264 encoder comprising the steps of:
determining whether H.264 inter-coding is present on the video, and when H.264 coding is not present;
computing a differential image for a current picture in the video;
encoding the differential image;
decoding and upsampling the differential image;
forming a new reference picture;
motion compensating the new reference picture; and
calculating a DC coefficient of motion compensated residual image information; and
encoding the DC coefficient of the motion compensated residual image information.

18. The method according to claim 17, further comprising the step of filtering the decoded and up-sampled differential image to remove blockiness.

19. The method according to claim 17, further comprising decoding received video that is not H.264 inter-coded in an H.264 decoder, said decoding further comprising the steps of:
decoding the encoded differential image up-sampling the decoded differential image;
forming a new reference picture from the up-sampled image and a reference picture store;
decoding the residual image information; and
motion compensating the new reference picture with the decoded residual image information to produce the current picture.

20. A coding apparatus for coding video to account for local brightness variation, the method comprising the steps of:
means generating a DC differential image by subtracting a current picture from a reference picture;
means for reconstructing the reference picture by adding the generated DC differential image;
means for motion compensating the reconstructed reference picture with respect to the video; and
means for encoding residue from the motion compensating means.

21. Apparatus for coding video to account for local brightness variation, the method comprising the steps of:
means for generating a DC differential image by subtracting a current picture from a reference picture;
means for reconstructing the reference picture by adding the generated DC differential image;
means for motion compensating the reconstructed reference picture with respect to the video; and
means for encoding residue from the motion compensating means.
